(19) United States
(12) Patent Application Publication
(10) Pub. No.: US 2026/0145878 A1
(43) Pub. Date: May 28, 2026

(54) TRANSPORT UNIT FOR SECONDARY BATTERY ELECTRODES AND METHOD THEREOF

(71) Applicant: HANA TECHNOLOGY CO., LTD., Yongin-si (KR)

(72) Inventors: Jeong Seok JEONG, Suwon-si (KR); Gyung Ryeol KWON, Yongin-si (KR); Hyuk Joong KWON, Osan-si (KR); Young Il SHIN, Ansan-si (KR); Eun Mi LEE, Hwaseong-si (KR)

(21) Appl. No.: 19/369,934

(22) Filed: Oct. 27, 2025

(30) Foreign Application Priority Data
Nov. 25, 2024 (KR) 10-2024-0169217

(51) Int. Cl. B65G 17/32; B65G 23/22; B65G 59/04; H01M 10/04

(52) U.S. Cl. CPC B65G 17/323; B65G 23/22; B65G 59/04; H01M 10/0404

(57) ABSTRACT

Embodiments relate to a transport unit for secondary battery electrodes and a method thereof, and more particularly, to a transport unit for secondary battery electrodes and a method thereof, wherein a portion of the transport unit is repeatedly rotated between an input position and an output position, thereby allowing an electrode supplied to the input position to be rapidly transported to the output position.

### CROSS REFERENCE TO RELATED APPLICATION

The present application claims priority to Korean Patent Application No. 10-2024-0169217, filed Nov. 25, 2024, the entire contents of which are incorporated herein by reference.

### BACKGROUND OF THE INVENTION

### Field of the Invention

The present disclosure relates to a transport unit for secondary battery electrodes and a method thereof. More particularly, the present disclosure relates to a transport unit for secondary battery electrodes and a method thereof, wherein a portion of the transport unit is repeatedly rotated between an input position and an output position, thereby allowing an electrode supplied to the input position to be rapidly transported to the output position.

### Description of the Related Art

Recently, with the significant development of electric vehicles, energy storage batteries, robots, and satellites, research on secondary batteries, that is, high-performance batteries capable of repeated charging and discharging, is actively ongoing. Currently, commercialized secondary batteries include nickel-cadmium batteries, nickel-metal-hydride batteries, nickel-zinc batteries, and lithium-ion secondary batteries. Among these, lithium-ion secondary batteries are in the limelight due to their advantages of free charge and discharge with almost no memory effect compared to nickel-based secondary batteries; an extremely low self-discharge rate; and high energy density.

The secondary battery has a structure where a cathode plate, a separator, and an anode plate are sequentially stacked and immersed in an electrolyte solution. To fabricate an internal cell stack of secondary batteries, a method is used where the anode plate and the cathode plate are cut to the required size and then the cut pieces are stacked in an alternating sequence: anode plate, separator, cathode plate, and separator. At this point, it is necessary to transport electrodes, including the cut cathode plate and anode plate, toward a stacking device.

In this regard, the inventors of the present disclosure would like to present a new type of transport unit for secondary battery electrodes and a method thereof, and details of which will be described below.

### Documents of Related Art

(Patent Document 1) Korean Patent No. 10-2628641 “Electrode film transfer device for secondary battery manufacturing system”

### SUMMARY OF THE INVENTION

Accordingly, the present disclosure has been made keeping in mind the above problems occurring in the related art, and an objective of the present disclosure is to provide a

transport unit for secondary battery electrodes and a method thereof, wherein the transport unit is capable of rapidly transporting electrodes supplied to an input position to an output position with a portion thereof repeatedly rotated between the input position and the output position.

Another objective of the present disclosure is to provide a transport unit for secondary battery electrodes and a method thereof, wherein the transport unit is capable of easy separation of multiple sheets of electrodes by generating pressure waves in the electrodes, which are vacuum-sucked by a suction unit, using a pulse valve. Yet another objective of the present disclosure is to provide a transport unit for secondary battery electrodes and a method thereof, wherein the transport unit is capable of efficient separation of multiple sheets of electrodes, as only some of multiple suction units perform separation of multiple sheets using a pulse valve.

Still another objective of the present disclosure is to provide a transport unit for secondary battery electrodes and a method thereof, wherein the transport unit is capable of easy separation of multiple sheets of electrodes by generating vibrations in the electrodes vacuum-sucked by a suction unit as a vertical drive actuator, which controls vertical movements of the suction unit, repeats vertical movements.

Still another objective of the present disclosure is to provide a transport unit for secondary battery electrodes and a method thereof, wherein the transport unit is capable of efficient separation of multiple sheets of electrodes as a vertical drive actuator repeats vertical movements with some of multiple suction units vacuum-sucking the electrodes.

Still another objective of the present disclosure is to provide a transport unit for secondary battery electrodes and a method thereof, wherein the transport unit is capable of preventing defects in a follow-up stacking process in advance with an electrode securing unit including a sensor that detects whether the suction unit vacuum-sucks multiple sheets of electrodes.

Still another objective of the present disclosure is to provide a transport unit for secondary battery electrodes and a method thereof, wherein the transport unit is capable of preventing various pneumatic lines or wires from being exposed outward as much as possible, with a through hole formed in a base member of a rotational moving unit and a hollow portion of a first rotating shaft member communicating with each other and storing the pneumatic lines or wires.

Still another objective of the present disclosure is to provide a transport unit for secondary battery electrodes and a method thereof, wherein the transport unit is capable of easily detecting the rotating angle and the relative position of a first rotating shaft member with a rotation detector.

Still another objective of the present disclosure is to provide a transport unit for secondary battery electrodes and a method thereof, wherein the transport unit is capable of efficiently separating the uppermost electrode and the electrode immediately below it among electrodes stacked in a magazine, with an electrode separating unit that sprays a fluid toward the plurality of electrodes supplied to an input position.

Still another objective of the present disclosure is to provide a transport unit for secondary battery electrodes and a method thereof, wherein the transport unit is capable of stopping a suction unit precisely at a desired position after the suction unit is rotated, with a deceleration control unit that minimizes inertia exerted in rotation of a first rotating shaft member.

Still another objective of the present disclosure is to provide a transport unit for secondary battery electrodes and a method thereof, wherein the transport unit is capable of allowing easy tension control of a timing belt with a tension control unit.

In order to achieve the above-described objectives, the present disclosure may be implemented by embodiments having the following configurations.

According to an embodiment of the present disclosure, the transport unit for secondary battery electrodes according to the present disclosure includes: a driving unit; an electrode securing unit having one portion that is configured to be move vertically, and vacuum-sucking electrodes introduced; a rotational moving unit rotated at one portion in a horizontal direction due to driving of the driving unit, and controlling the electrode securing unit so that the electrode securing unit is reciprocally rotated between an input position and an output position.

According to another embodiment of the present disclosure, the electrode securing unit of the transport unit for secondary battery electrodes according to the present disclosure may include a suction unit comprising a suction pad at a lower portion thereof to vacuum-suck the electrodes; and a vertical drive actuator controlling vertical movement of the suction unit.

According to another embodiment of the present disclosure, the suction unit of the transport unit for secondary battery electrodes according to the present disclosure may include a pulse valve communicating with the suction pad.

According to another embodiment of the present disclosure, the vertical drive actuator of the transport unit for secondary battery electrodes according to the present disclosure may include a servo cylinder.

According to another embodiment of the present disclosure, the vertical drive actuator of the transport unit for secondary battery electrodes according to the present disclosure may be configured to repeat vertical movements to separate multiple sheets of electrodes that are vacuum-sucked by the suction unit.

According to another embodiment of the present disclosure, the pulse valve of the transport unit for secondary battery electrodes according to the present disclosure may be configured to generate pressure waves in the electrodes, which are vacuum-sucked by the suction unit, to separate multiple sheets of electrodes that are vacuum-sucked by the suction unit.

According to another embodiment of the present disclosure, the suction unit of the transport unit for secondary battery electrodes according to the present disclosure may include a plurality of suction units that are spaced apart from each other, and the pulse valve of the suction unit, which sucks opposite ends or edges of the electrodes, may generate pressure waves to the electrodes along the suction pad corresponding thereto.

According to another embodiment of the present disclosure, the electrode securing unit of the transport unit for secondary battery electrodes according to the present disclosure may include: a coupling plate extending in a first direction; and a suction unit securing member coupled to the coupling plate and provided with the suction unit that is fixed to one portion of the suction unit securing member, wherein the coupling plate may include: a first long hole extending in the first direction, and the suction unit securing member may include: a fastening hole matching the first long hole so that a coupling means may be inserted.

According to another embodiment of the present disclosure, the electrode securing unit of the transport unit for secondary battery electrodes according to the present disclosure may include: a coupling plate extending in a first direction; and a suction unit securing member coupled to the coupling plate and provided with the suction unit that is fixed to one portion of the suction unit securing member, wherein the suction unit securing member may include: a second long hole extending in a second direction orthogonal to the first direction, and the suction unit may be inserted into the second long hole.

According to another embodiment of the present disclosure, the transport unit for secondary battery electrodes according to the present disclosure may include: a multi-sheet detecting unit configured to detect whether the suction unit vacuum-sucks multiple sheets of electrodes, wherein the multi-sheet detecting unit may include: a transmitter located at one portion of the electrode securing unit; and a receiver located below the transmitter.

According to another embodiment of the present disclosure, the rotational moving unit of the transport unit for secondary battery electrodes according to the present disclosure may include: a base member to which one portion of the electrode securing unit is coupled; and a first rotating shaft member arranged below the base member and rotated in a horizontal direction using a rotatory force transmitted by the driving unit, wherein the base member may include: a through hole formed in a vertical direction, and the first rotating shaft member may include: a hollow portion extending in the vertical direction and communicating with the through hole.

According to another embodiment of the present disclosure, the rotational moving unit of the transport unit for secondary battery electrodes according to the present disclosure may further include: a cover that covers the first rotating shaft member and is fixed at its regular position; and a rotation detector provided on an outer surface of the cover, and detecting a rotating angle or a relative position of the first rotating shaft member, and the electrode securing unit may include: a protruding member protruding from one portion of the electrode securing unit, and passing through one portion of the rotation detector.

According to another embodiment of the present disclosure, the transport unit for secondary battery electrodes according to the present disclosure may further include: an electrode separating unit that sprays a fluid to the electrodes supplied to the input position.

According to another embodiment of the present disclosure, the electrode separating unit of the transport unit for secondary battery electrodes according to the present disclosure may include: a pair of securing portions spaced apart from each other in the first direction; a connection rod having opposite ends that are respectively connected to the pair of securing portions; and a fluid supply member coupled to the connection rod, and spraying fluid outward.

According to another embodiment of the present disclosure, the transport unit for secondary battery electrodes according to the present disclosure may further include: a deceleration control unit transmitting a rotatory force generated by the driving unit to the rotational moving unit.

According to another embodiment of the present disclosure, the rotational moving unit of the transport unit for secondary battery electrodes according to the present disclosure may include: a base member to which one portion of the electrode securing unit is coupled; and a first rotating shaft member arranged below the base member and rotated in a horizontal direction using a rotatory force transmitted by the driving unit, and the driving unit may include a second rotating shaft member extending in a vertical direction, and the deceleration control unit may include: a first timing pulley coupled onto the second rotating shaft member, and including first gear teeth formed along an outer circumferential surface thereof; a second timing pulley coupled onto the first rotating shaft member, and including second gear teeth formed along an outer circumferential surface thereof; and a timing belt surrounding the outer circumferential surfaces of the first timing pulley and the second timing pulley.

According to another embodiment of the present disclosure, the electrode securing unit of the transport unit for secondary battery electrodes according to the present disclosure may include a plurality of electrode securing units that are arranged on the rotational moving unit while being spaced from each other at a predetermined angle in a rotating direction of the rotational moving unit.

According to an embodiment of the present disclosure, a method for transporting secondary battery electrodes of the present disclosure may include: vacuum-sucking, by the suction unit, an electrode located at the uppermost end among a plurality of electrodes that are stacked in a magazine; rotating, by driving of the driving unit, the rotational moving unit forward in a horizontal direction; finishing, by the suction unit, vacuum suction with respect to the electrode after forward rotation of the rotational moving unit; and rotating, by driving of the driving unit, the rotational moving unit backward in the horizontal direction to be returned to its original position.

According to another embodiment of the present disclosure, the method of the present disclosure may further include an electrode separating unit configured to supply fluid to electrodes supplied to the input position, and spraying the fluid onto a plurality of electrodes that are stacked in the magazine before the suction unit vacuum-sucks the electrode.

According to another embodiment of the present disclosure, the electrode securing unit of the method of the present disclosure may include: a pulse valve communicating with the suction pad, and the method may further include: after the suction unit vacuum-sucks the electrodes, generating pressure waves through the pulse valve and separating multiple sheets of electrodes sucked by the suction unit.

According to another embodiment of the present disclosure, the electrode securing unit of the method of the present disclosure may further include: a vertical drive actuator controlling upward and downward movements of the suction unit, and the method may further include: with repeated upward and downward movements of the vertical drive actuator, separating multiple sheets of electrodes sucked by the suction unit.

According to another embodiment of the present disclosure, the electrode securing unit of the method of the present disclosure may include: a pulse valve connected to the suction pad; and a vertical drive actuator controlling upward and downward movements of the suction unit, and the method may further include: after the suction unit vacuum-sucks the electrodes, generating pressure waves through the pulse valve and separating multiple sheets of electrodes sucked by the suction unit; and the method may further include: with repeated upward and downward movements of the vertical drive actuator, separating multiple sheets of electrodes sucked by the suction unit.

The present disclosure has the following effects with the above-described configuration.

The transport unit of the present disclosure can rapidly transport electrodes supplied to an input position to an output position with a portion thereof repeatedly rotated between the input position and the output position.

Furthermore, the transport unit of the present disclosure can easily separate multiple sheets of electrodes by generating pressure waves in the electrodes vacuum-sucked by the suction unit, using the pulse valve.

Furthermore, the transport unit of the present disclosure can efficiently separate multiple sheets of electrodes with some of multiple suction units performing multi-sheet separation using the pulse valve.

Furthermore, the transport unit of the present disclosure can easily separate multiple sheets of electrodes by generating vibrations in the electrodes vacuum-sucked by the suction unit with repeated vertical movements of a vertical drive actuator, which controls vertical movements of the suction unit.

Furthermore, the transport unit of the present disclosure can efficiently separate multiple sheets of electrodes as the vertical drive actuator repeats vertical movements with some of the multiple suction units vacuum-suck the electrodes.

Furthermore, the transport unit of the present disclosure can prevent defects in a follow-up stacking process in advance with the electrode securing unit including a sensor that detects whether the suction unit vacuum-sucks multiple sheets of electrodes.

Furthermore, the transport unit of the present disclosure can prevent various pneumatic lines or wires from being exposed outward as much as possible with the through hole formed in the base member of the rotational moving unit and the hollow portion of the first rotating shaft member that communicate with each other and store the pneumatic lines or wires therein.

Furthermore, the transport unit of the present disclosure can easily detect the rotating angle or the relative position of the first rotating shaft member with the rotation detector.

Furthermore, the transport unit of the present disclosure can efficiently separate the uppermost electrode and the electrode immediately below it among a plurality of electrodes stacked in the magazine, with the electrode separating unit that sprays a fluid toward the plurality of electrodes supplied to an input position.

Furthermore, the transport unit of the present disclosure can stop the suction unit precisely at a desired position after rotation of the suction unit with the deceleration control unit that minimizes inertia exerted in rotation of a first rotating shaft member.

Furthermore, the transport unit of the present disclosure can easily control the tension of the timing belt with the tension control unit.

Meanwhile, it should be added that even if the effects are not explicitly mentioned herein, the effects described in the following specification expected by the technical features of the present disclosure and their potential effects can be treated as if they were described in the specifications of the present disclosure.

### BRIEF DESCRIPTION OF THE DRAWINGS

FIG. 1 is a perspective view in one direction, the view showing a transport unit for secondary battery electrodes according to an embodiment of the present disclosure.

FIG. 2 is a perspective view in another direction, the view showing the transport unit for secondary battery electrodes of FIG. 1.

FIG. 3 is a side view in one direction, the view showing the transport unit for secondary battery electrodes of FIG. 1.

FIG. 4 is a front view showing an electrode securing unit of FIG. 1.

FIG. 5 is a side view showing the electrode securing unit of FIG. 4.

FIG. 6 is a bottom view showing the electrode securing unit of FIG. 4.

FIG. 7 is an illustrative view showing a rotational moving unit of FIG. 1.

FIG. 8 is a front view showing a multi-sheet separating unit of FIG. 1.

FIG. 9 is a perspective view showing the multi-sheet separating unit of FIG. 8.

FIG. 10 is an illustrative view showing a deceleration control unit of FIG. 1.

FIG. 11 is an illustrative view showing a tension control unit of FIG. 1.

FIGS. 12 to 15 are illustrative views showing a method of transporting secondary battery electrodes according to an embodiment of the present disclosure.

### DETAILED DESCRIPTION OF THE DISCLOSURE

Hereinbelow, an embodiment of the present disclosure will be described in detail with reference to accompanying drawings. The embodiments of the present disclosure may be modified in various forms, and the scope of the present disclosure should not be construed as being limited to the following embodiments, but should be construed based on the matters described in the claims. In addition, these embodiments are only provided for reference in order to more completely explain the present disclosure to those of ordinary skill in the art.

As used herein, the singular forms “a”, “an” and “the” are intended to include the plural forms as well, unless the context clearly indicates otherwise. It will be further understood that the terms “comprise” and/or “comprising” when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, it should be noted that when one component (or layer) is described as being disposed on another component (or layer), one component may be disposed directly on another component, or another component(s) or layer(s) may be located between the components. In addition, when one component is expressed as being directly disposed on or above another component, no other component(s) are located between the components. Moreover, being located on “top”, “upper”, “lower”, “bottom”, “one (first) side”, or “side” of a component means a relative positional relationship.

Furthermore, some components will be described using the terms such as “first”, “second”, and the like. It should be understood that the second component does not presuppose the first component, and one component is independent of the other.

Hereinbelow, it will be understood that when an element is referred to as being “coupled” or “connected” to another element, it can be directly coupled or connected to the other element or indirectly coupled or connected thereto with intervening elements.

The term “electrode” as used herein may include, for example, an anode plate and/or a cathode plate.

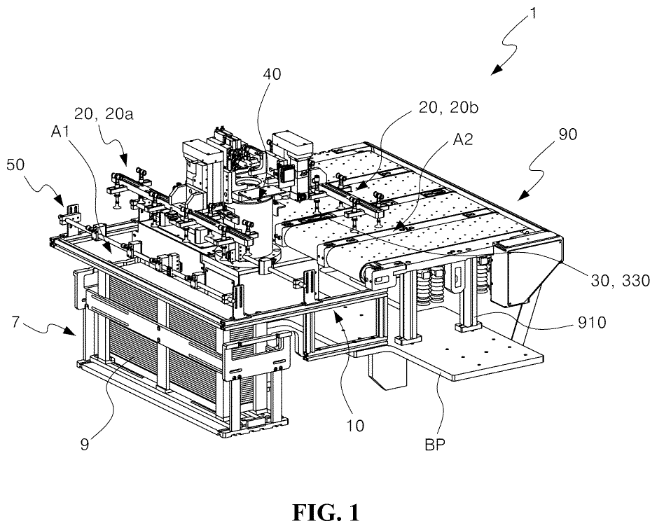

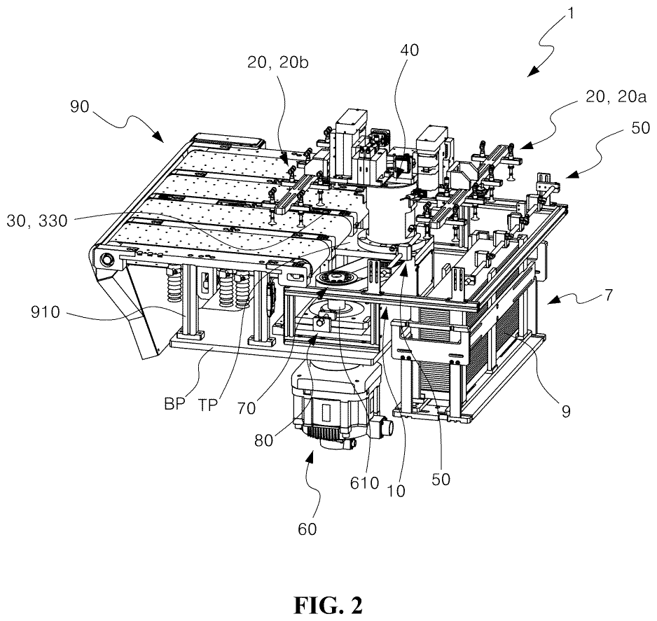

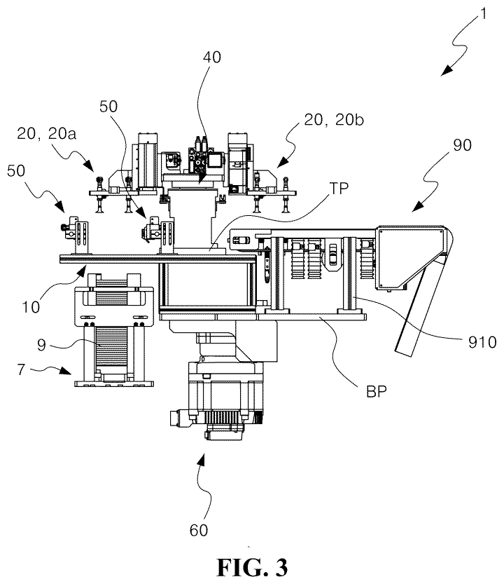

FIG. 1 is a perspective view in one direction, the view showing a transport unit for secondary battery electrodes according to an embodiment of the present disclosure. FIG. 2 is a perspective view in another direction, the view showing the transport unit for secondary battery electrodes of FIG. 1. FIG. 3 is a side view in one direction, the view showing the transport unit for secondary battery electrodes of FIG. 1.

Hereinbelow, according to the embodiment of the present disclosure, a transport unit 1 for secondary battery electrodes will be described in detail with reference to accompanying drawings.

Referring to FIGS. 1 to 3, the present disclosure relates to a transport unit 1 for secondary battery electrodes and, more particularly, to a transport unit 1 for secondary battery electrodes, one portion of the transport unit being repeatedly rotated between an input position A1 and an output position A2 in a horizontal direction, thereby rapidly transporting electrodes 9 that are supplied to the input position A1 to the output position A2.

The above term “the input position A1” indicates a position where the electrodes 9 are supplied to the transport unit 1 for secondary battery electrodes. For example, the electrodes 9 may be a plurality of electrodes 9 staked in the magazine 7 and may be supplied to the input position A1. The magazine 7 may be configured to be move vertically at a predetermined height or fixed at its regular position.

Furthermore, the term “the output position A2” indicates a position where the electrodes 9 rotatably transported by the transport unit 1 for secondary battery electrodes are discharged. For example, the input position A1 and the output position A2 may be spaced from each other at 180° in a rotating direction of a rotational moving unit 40, which will be described below, but the scope of the present disclosure is not limited to the above numerical range. Furthermore, a transport belt 90 to be described below may be disposed at the output position A2. For example, the electrodes 9 stacked in the magazine 7 may be supplied to the input position A1 together with the magazine 7, and discharged toward the transport belt 90 located at the output position A2. The transport belt 90 may include a plurality of suction holes to suck the electrode 9 seated on the transport belt 90.

To this end, according to the embodiment of the present disclosure, the transport unit 1 for secondary battery electrodes may include a base frame 10, an electrode securing unit 20, the multi-sheet detecting unit 30, the rotational moving unit 40, an electrode separating unit 50, a driving unit 60, a deceleration control unit 70, a tension control unit 80, and the transport belt 90.

The base frame 10 is a frame and, for example, has a planar shape of a rectangular band, but the scope of the present disclosure is not limited thereto. Furthermore, the electrode separating unit 50 may be coupled to the base frame 10. For example, a pair of electrode separating units 50 may be fixed on an upper surface of the base frame 10 with a gap therebetween. Furthermore, the rotational moving unit 40 and the magazine 7 may be located in the inner space of the base frame 10. The base frame 10 may be fixed on the base plate BP. The above base plate BP may be a plate form disposed below the base frame 10.

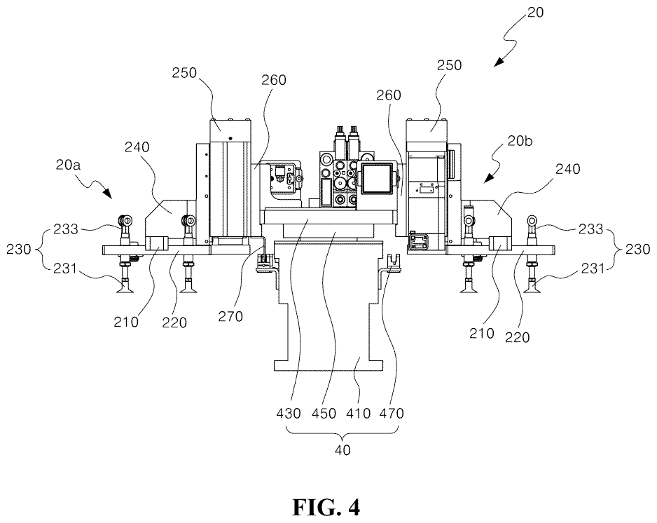

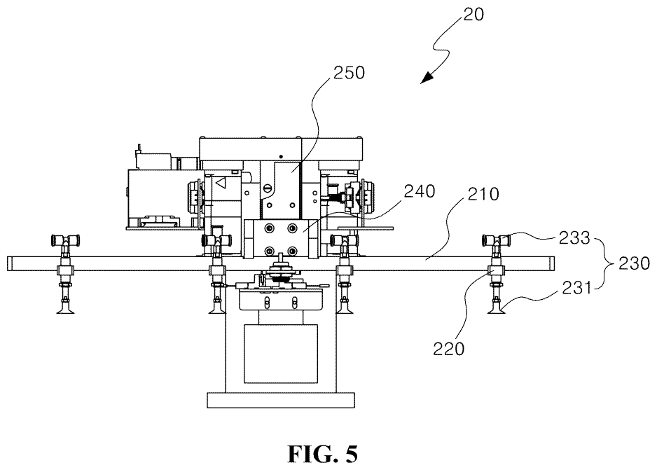

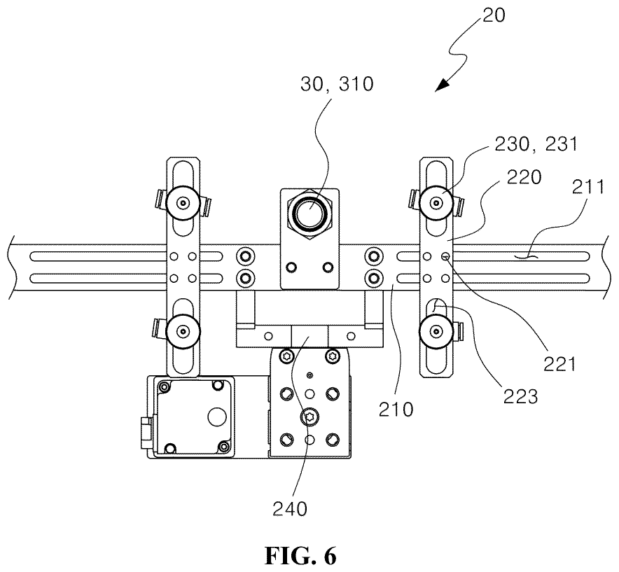

FIG. 4 is a front view showing an electrode securing unit of FIG. 1. FIG. 5 is a side view showing the electrode securing unit of FIG. 4. FIG. 6 is a bottom view showing the electrode securing unit of FIG. 4.

Referring to FIGS. 4 to 6, the electrode securing unit 20 is configured such that a portion thereof vacuum-sucks the electrodes 9 supplied to the input position A1. Furthermore, the electrode securing units 20 may be disposed above the electrodes 9 supplied to the input position A1. Another portion of the electrode securing unit 20 may be coupled to the rotational moving unit 40 and repeatedly rotated between the input position A1 and the output position A2 with the rotation of the rotational moving unit 40. As described below, a plurality of electrode securing units 20 may be disposed while being spaced from each other in the rotating direction of the rotational moving unit 40. As an example, a pair of electrode securing units 20 may be spaced at 180° from each other in the rotating direction of the rotational moving unit 40. In other words, when one of the electrode securing units 20 is located at the input position A1, the other one of the electrode securing units 20 may be located at the output position A2. For convenience of description, one of the electrode securing units 20 is referred to as a first electrode securing unit 20a, and the other one of the electrode securing units 20 is referred to as a second electrode securing unit 20b.

Furthermore, the electrode securing unit 20 may include a coupling plate 210, a suction unit securing member 220, a suction unit 230, a first connecting member 240, a vertical drive actuator 250, a second connecting member 260, and a protruding member 270.

The coupling plate 210 extends longer in the horizontal direction (hereinafter referred to as “the first direction”), for example, and may have a plate form. The suction unit securing member 220 and the first connecting member 240 may be coupled to the coupling plate 210. For example, the suction unit securing member 220 may be coupled to a bottom surface of the coupling plate 210, and the first connecting member 240 may be coupled to an upper surface of the coupling plate 210. In some cases, the coupling plate 210 may be integrally formed with the suction unit securing member 220 and/or the first connecting member 240.

Furthermore, the coupling plate 210 may have a first long hole 211 formed in the first direction (referring to FIG. 6). The first long hole 211 is a through hole, and may be a single first long hole formed in the first direction, or a plurality of first long holes formed in the first direction and spaced apart from each other, and there is no limitation thereto. Furthermore, the first long hole 211 may include a plurality of first long holes spaced apart from each other in a second direction orthogonal to the first direction on a level surface.

After the first long hole 211 matches a first fastening hole 221 formed in the suction unit securing member 220, a coupling means (not shown), for example, a bolt, etc., may be inserted into the aligned hole so that the suction unit securing member 220 is fixed to the coupling plate 210 by inserting. Furthermore, as described above, since the first long hole 211 extends longer in the first direction, a fabricator can determine a fixing position in the first direction of the suction unit securing member 220 and/or the suction unit 230. Therefore, the fabricator may easily change a fixing position of the suction unit securing member 220 and/or the suction unit 230 according to the shape, the length, or the size of the electrodes 9.

The suction unit securing member 220 is coupled to the coupling plate 210 and is provided with the suction unit 230, which is fixed to one portion of the suction unit securing member 220. For example, the suction unit securing member 220 may extend longer in the second direction. Furthermore, the suction unit securing member 220 may preferably be a plurality of suction unit securing members 220, which are spaced apart from each other in the first direction. Therefore, the plurality of suction unit securing members 220 may be spaced apart from each other in a longitudinal direction of the coupling plate 210 or the first direction. As described above, the suction unit securing member 220 may be coupled to the coupling plate 210 by matching the first fastening hole 221 and the first long hole 211, and fastening the coupling means thereto, but there is no separate limitation to the coupling method of both configurations, and in some cases the suction unit securing member 220 may be formed to be integrated with the coupling plate 210. The first fastening hole 221 of the suction unit securing member 220 may be a plurality of first fastening holes 221 that are formed to be spaced apart from each other in the second direction.

Furthermore, the suction unit securing member 220 may include a second long hole 223. The second long hole 223 is a through hole extending longer in the second direction, and may include a plurality of second long holes 223 spaced apart from each other in the second direction, but the scope of the present disclosure is not limited thereto. The suction unit 230 may be inserted into the second long hole 223 and fixed to one portion of the suction unit securing member 220. Therefore, the second long hole 223 may include the number of second long holes 223 corresponding to the number of suction units 230.

The suction unit 230 is configured to be fixed to the suction unit securing member 220 and vacuum-suck the electrodes 9. The suction unit 230 is inserted into the second long hole 223 and fixed to the suction unit securing member 220, so the fabricator can easily change the fixed position of the suction unit 230 in the second direction. Furthermore, a suction pad 231 may be formed at a lower portion of the suction unit 230. Therefore, the electrodes 9 supplied to the input position A1 are vacuum-sucked by the suction pad 231 and rotated together with the suction unit 230, thereby being transported to the output position A2. Furthermore, the suction unit 230 may include a plurality of suction units 230 spaced apart from each other in the first direction and, for example, spaced at an equal interval from each other in the first direction, but the scope of the present disclosure is not limited thereto.

Furthermore, a valve 233 may be formed at an upper portion of the suction unit 230. The valve 233 may, for example, be a pulse valve. The suction unit 230 consisting of the pulse valve may generate pressure waves that flow along an inner portion of the suction pad 231. For example, the valve 233 may be a MAC valve. Therefore, when the suction pad 231 vacuum-sucks the plurality of electrodes 9 staked in the magazine 7, the valve 233 pressure waves are generated by the operation of the valve 233 in the electrodes 9 and sucked, so that the uppermost electrode 9 of the multiple electrodes vacuum-sucked by the suction pad 231 may be separated from other electrodes 9. In other words, the valve 233 of a pulse valve is operated to allow the separation of multiple sheets of the electrodes 9.

For example, during the separation of multiple sheets, a valve 233 of a portion of the plurality of suction units 230, which are spaced apart from each other in the first direction, is operated, thereby generating pressure waves through the corresponding suction pad 231. For

example, among the plurality of suction units 230, the suction unit 230, which sucks a central portion of the electrodes 9, does not perform multi-sheet separation, and the edge suction unit 230, which sucks a portion between the central portion of the electrodes 9 and the first directional end, may perform multi-sheet separation. Therefore, the efficiency of separating multiple sheets of the electrodes 9 can be improved.

The first connecting member 240 has a first portion coupled to the coupling plate 210 and a second portion coupled to the vertical drive actuator 250, and may be formed from a single member or by coupling a plurality of members to each other, and there is no separate limitation thereto. Furthermore, the first connecting member 240 is coupled to the vertical drive actuator 250 and can be moved vertically when the drive actuator 250 is activated. At this point, the suction unit 230 connected to the first connecting member 240 may also be moved vertically.

The vertical drive actuator 250 has a first portion coupled to the first connecting member 240 and a second portion coupled to a portion of the rotational moving unit 40 to control upward and downward movements of the suction unit 230. At this point, the vertical drive actuator 250 may be directly coupled to the rotational moving unit 40 or coupled to the rotational moving unit 40 by the second connecting member 260, and there is no separate limitation thereto. For example, when the suction unit 230 vacuum-sucks two or more sheets of electrodes 9 stacked in the magazine 7, repeated vertical movement of the vertical drive actuator 250 generates vibrations in the electrodes 9, thereby separating the uppermost electrode 9 that is vacuum-sucked by the suction unit 230 from other electrodes 9. For example, while some of the suction units 230 vacuum-suck the electrodes 9, and a remaining part of the suction units 230 does not vacuum-suck the electrodes 9 or supplies pressure waves to the electrodes 9 using the valve 233, the vertical drive actuator 250 repeats vertical movements to generate vibrations in the electrodes 9. For example, among the plurality of suction units 230, a suction unit 230 located at a central portion of the electrodes 9 vacuum-sucks the electrodes 9, and an edge suction unit 230 located between the central portion of the electrodes 9 and a first-directional end does not vacuum-suck the electrodes 9 or provides pressure waves in the electrodes 9 using the valve 233, the vertical drive actuator 250 may repeat vertical movement.

Therefore, multiple sheets of electrodes 9 vacuum-sucked by the suction unit 230 may be separated by the valve 233, and the vertical drive actuator 250 repeating vertical movement. To this end, the vertical drive actuator 250 may include, for example, a servo cylinder or an electric cylinder, but the scope of the present disclosure is not limited thereto.

The second connecting member 260 may have a first portion connected to the vertical drive actuator 250 and a second portion connected to a portion of the rotational moving unit 40, and may be formed from a single member or by coupling of members to each other, and there is no limitation thereto. Therefore, when the portion of the rotational moving unit 40 is rotated in the horizontal direction, the second connecting member 260 is also rotated, and the suction unit 230 vacuum-sucking the electrodes 9 may also be rotated.

The protruding member 270 is coupled preferably to a portion of the electrode securing unit 20, and preferably, coupled to a portion of the second connecting member 260, and is an object that is detected by the rotation detector 470 (referring to FIG. 4). For example, the protruding member 270 protrudes downward from a lower surface of the second connecting member 260, and passes through a portion of the rotation detector 470 or inserted into the portion of the rotation detector 470, thereby allowing the rotation detector 470 to detect a rotating angle or a relative position of the electrode securing units 20 and/or the portion of the rotational moving unit 40.

As described above, the electrode securing unit 20 is not a single vacuum-sucking plate that extends in the first direction, but may include the coupling plate 210, the suction unit securing member 220, and the suction unit 230. Therefore, the structure for vacuum-sucking the electrodes 9 may be formed to be relatively lighter than a single vacuum-sucking plate. Therefore, the inertia exerted when a portion of the rotational moving unit 40 is rotated is minimized, so that the suction unit 230 may be precisely stopped at the input position A1 and the output position A2 after being rotated.

Referring to FIGS. 1, 2, and 6, the multi-sheet detecting unit 30 is a sensor that detects whether multiple sheets of electrodes 9 are vacuum-sucked at a portion of the electrode securing unit 20. For example, the multi-sheet detecting unit 30 may include a transmitter 310 generating a detectable signal and a receiver 330 receiving the detectable signal. The transmitter 310 may be installed at a position of the coupling plate 210 or a position adjacent to the coupling plate 210 (referring to FIG. 6). Furthermore, the receiver 330 may be installed at a portion of the transport belt 90 (referring to FIGS. 1 and 2). At this point, the transmitter 310 and the receiver 330 are preferably positioned to match each other in the vertical direction. Furthermore, the multi-sheet detecting unit 30 may, for example, be an ultrasonic sensor, but the scope of the present disclosure is not limited thereto, and may be any sensor that is known to measure the thickness of the electrodes 9. Therefore, the multi-sheet detecting unit 30 is used to detect whether the suction unit 230 vacuum-sucks multiple sheets or more of electrodes 9. When the multi-sheet detecting unit 30 detects that the suction unit 230 vacuum-sucks two or more sheets of electrodes 9, the electrodes 9 may be discharged outside the transport unit 1 for secondary battery electrodes by the transport belt 90 located at the output position A2.

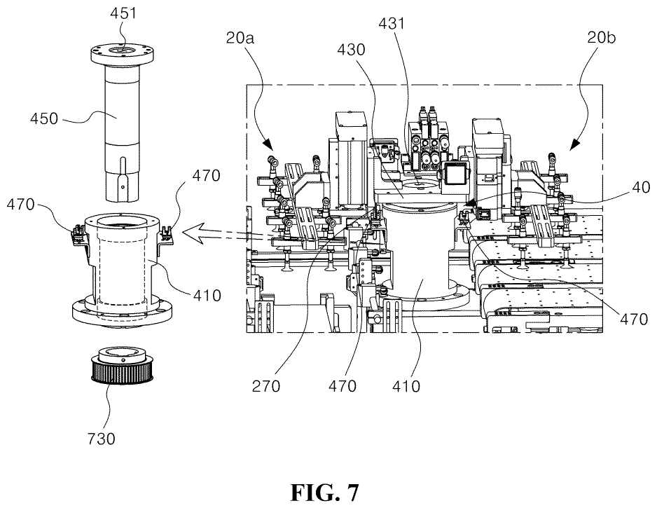

FIG. 7 is an illustrative view of the rotational moving unit of FIG. 1.

Referring to FIG. 7, a portion of the rotational moving unit 40 is rotated by a rotatory force transmitted by the driving unit 60 and/or the deceleration control unit 70, thereby controlling the electrode securing unit 20 so that the electrode securing unit 20 is repeatedly rotated between the input position A1 and the output position A2. To this end, the rotational moving unit 40 may include a cover 410, a base member 430, a first rotating shaft member 450, and the rotation detector 470.

The cover 410 is configured to cover the first rotating shaft member 450 and may have, for example, a cylindrical structure. Therefore, the cover 410 may be disposed to surround the first rotating shaft member 450. The cover 410 may maintain a fixed state at a regular position without being rotated even when the driving unit 60 is driven. To this end, the cover 410 may be fixed onto the top plate TP (referring to FIG. 2). The top plate TP may have a plate form that is spaced upward from the base plate BP.

The base member 430 may be disposed on the cover 410 and/or the first rotating shaft member 450, and have a plate form. For example, the base member 430 may be coupled to an upper surface of the first rotating shaft member 450 and rotated together with rotation of the first rotating shaft member 450. Furthermore, a portion of the electrode securing unit 20 may be coupled to the base member 430. For example, the second connecting member 260 may be coupled to an upper portion of the base member 430 (referring to FIG. 4). Furthermore, the base member 430 may be coupled to the pair of electrode securing units 20a and 20b. At this point, the pair of electrode securing units 20a and 20b may be spaced from each other to face each other, and a portion of each electrode securing unit may be coupled to the base member 430. In detail, the pair of electrode securing units 20a and 20b may be disposed to be spaced at 180° from each other in a rotating direction of the first rotating shaft member 450. Therefore, the pair of electrode securing units 20a and 20b may be disposed symmetrically to each other based on the base member 430 located therebetween.

Furthermore, a through hole 431 may be formed at a portion of the base member 430, more preferably, on a central portion of the base member 430. The through hole 431 is formed vertically through the base member 430, and may communicate with a hollow portion 451 of the first rotating shaft member 450, which will be described below.

The first rotating shaft member 450 is disposed below the base member 430 and configured to be rotated in the horizontal direction by a rotatory force that is transmitted by the driving unit 60. Furthermore, the hollow portion 451 may be formed in the first rotating shaft member 450. The hollow portion 451 communicates with the through hole 431 of the base member 430, and may supply a space where a pneumatic line, which is connected to a portion of the suction unit 230 and/or the vertical drive actuator 250, or various wires are stored therein. Therefore, the pneumatic line, etc., is maximally prevented from being exposed outside the transport unit 1 for secondary battery electrodes, thereby preventing damage to the transport unit 1 for secondary battery electrodes, and preventing the pneumatic line, etc., from being twisted due to rotation of the electrode securing unit 20.

The rotation detector 470 is disposed on an outer surface of the cover 410 and configured to detect a rotating angle or a position of the electrode securing units 20 and/or the first rotating shaft member 450. The rotation detector 470 may, for example, be a micro photoelectric sensor, and the micro photoelectric sensor has a horseshoe (U) shape and is referred to as a horseshoe sensor or a horseshoe-type optical electric sensor. However, the rotation detector 470 is not limited to the above example, and it is noted that the rotation detector 470 may include any suitable sensor for specifying the rotating angle or the relative position of the electrode securing units 20 and/or the first rotating shaft member 450. For example, the rotation detector 470 detects the protruding member 270 to detect the rotating angle or the position of the electrode securing units 20 and/or the first rotating shaft member 450. Therefore, the rotation detector 470 is preferably fixed at a height substantially the same as the protruding member 270.

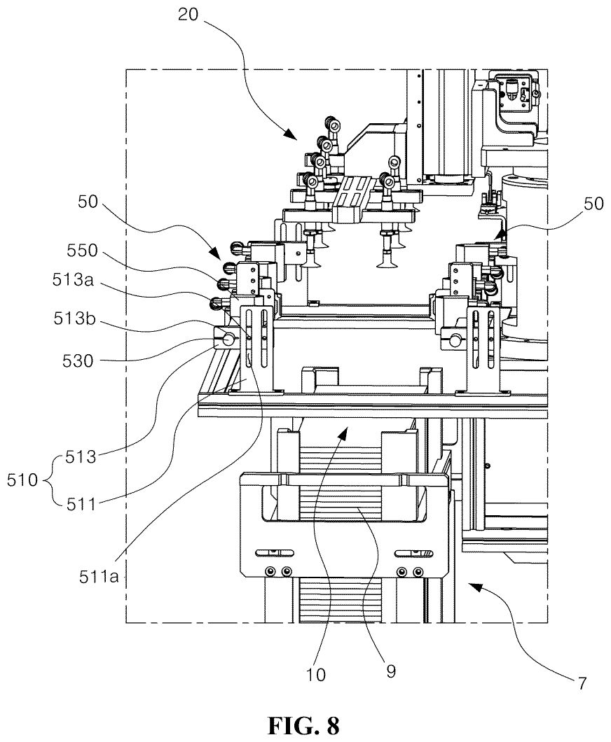

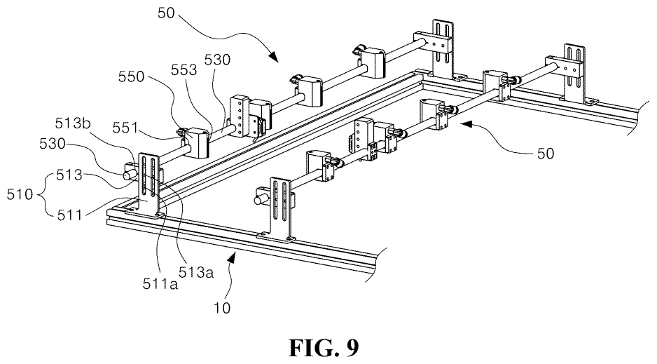

FIG. 8 is a front view showing a multi-sheet separating unit of FIG. 1. FIG. 9 is a perspective view showing the multi-sheet separating unit of FIG. 8.

Referring to FIGS. 8 and 9, the electrode separating unit 50 is installed at the input position A1 or a position adjacent to the input position A1 and is configured to spray a fluid onto the electrodes 9 before they are vacuum-sucked by the electrode securing units 20. The electrode separating unit 50 may, for example, be fixed on the base frame 10, but there is no limitation to the fixed position. The electrode separating unit 50 may be securely installed at a regular position regardless of the rotation of a portion of the rotational moving unit 40.

For example, the electrode separating unit 50 may include a pair of electrode separating units 50 that are spaced apart from each other along the electrodes 9, which are supplied to the input position A1, in the second direction. Therefore, the pair of electrode separating unit 50 may be installed to face each other. For example, a plurality of electrodes 9 stacked in the magazine 7 may be inserted into the height of the electrode separating units 50 as the magazine 7 is moved upward. At this point, the electrode separating units 50 spray a fluid onto the plurality of electrodes 9 stacked, thereby separating the uppermost electrode 9 from the electrode 9 stacked below it in at least one portion. The suction unit 230 may easily vacuum-suck a single electrode 9 by the electrode separating unit 50. Furthermore, the fluid spraying onto the adjacent electrodes 9 via the electrode separating units 50 is used to remove static from the plurality of electrodes 9 stacked in the magazine 7.

To this end, each of the electrode separating units 50 may include a securing portion 510, a connection rod 530, and a fluid supply member 550.

The securing portion 510 is provided to secure the connection rod 530, and may be coupled to an upper portion of the base frame 10. The securing portion 510 includes a pair of securing portions disposed to be spaced apart from each other in the first direction, and may secure opposite ends of the connection rod 530.

Furthermore, each of the securing portions 510 may include, for example, a vertical plate member 511 and a horizontal plate member 513.

The vertical plate member 511 has a plate form extending in a vertical direction and, for example, may be securely installed at the upper portion of the base frame 10. Furthermore, the vertical plate member 511 may include a third long hole 511a that extends in the vertical direction. The third long hole 511a and a coupling hole 513a of the horizontal plate member 513 match each other, and then a coupling means, such as a bolt, is inserted into the holes, so that the horizontal plate member 513 is coupled to the vertical plate member 511. Therefore, the fabricator may appropriately select a coupling height of the horizontal plate member 513 according to a longitudinal direction of the third long hole 511a.

The horizontal plate member 513 has a plate form that is coupled to the vertical plate member 511, and is preferably coupled to an upper surface of the vertical plate member 511. The horizontal plate member 513 may include the coupling hole 513a, as described above. Furthermore, the horizontal plate member 513 may include a first inserting hole 513b on a portion spaced apart from the coupling hole 513a. Both the coupling hole 513a and the first inserting hole 513b may be a through hole or a depressed hole extending in the first direction. An end portion of the connection rod 530 may be inserted into the first inserting hole 513b.

Opposite end portions of the connection rod 530 are inserted into a pair of the first inserting hole 513b of the horizontal plate member 513, and may have, for example, a rod shape. Furthermore, the connection rod 530 is inserted into a portion of the fluid supply member 550, allowing the fluid supply member 550 to be secured at a height of the connection rod 530.

The fluid supply member 550 is coupled to the connection rod 530 and configured to spray the fluid to the adjacent electrodes 9, thereby separating the plurality of electrodes 9 stacked in the magazine 7 from each other. The above term “fluid” is a gas, such as air, but the scope of the present disclosure is not limited to the above example. Furthermore, the fluid supply member 550 may include a plurality of fluid supply members 550 that are spaced apart from each other in the first direction or a longitudinal direction of the connection rod 530. Furthermore, each of the fluid supply members 550 may include a second inserting hole 551 into which the connection rod 530 is inserted. The second inserting hole 551 may be a through hole extending in the first direction. Furthermore, the fluid supply member 550 may include fluid spray holes 553 at a portion thereof. The fluid spray hole 553 may be formed on one surface of the fluid supply member 550 facing the electrodes 9 supplied through the magazine 7 and sprays a fluid, and may include a plurality of fluid spray holes 553 spaced apart from each other in the vertical direction.

Referring to FIGS. 2 and 3, the driving unit 60 is configured to generate a rotatory force. For example, the driving unit 60 may include a servomotor, but the scope of the present disclosure is not limited thereto, and it may be any known configuration that generates a rotatory force. The driving unit 60 may include a second rotating shaft member 610 (referring to FIG. 2).

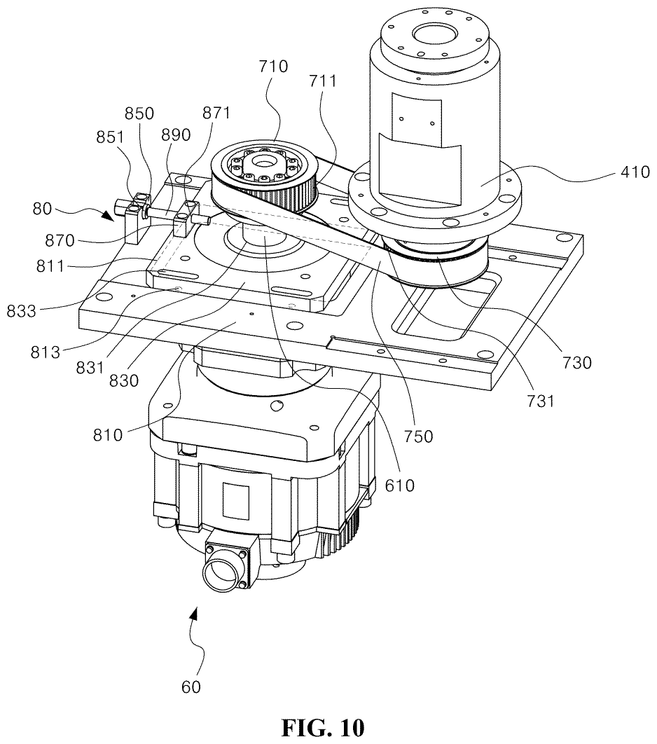

FIG. 10 is an illustrative view showing a deceleration control unit of FIG. 1.

Referring to FIGS. 2 and 10, the deceleration control unit 70 is configured to transmit a rotatory force generated through the driving unit 60 to a portion of the rotational moving unit 40. To this end, the deceleration control unit 70 may include a first timing pulley 710, a second timing pulley 730, and a timing belt 750. However, the deceleration control unit 70 is not an essential component of the present disclosure, and a general reducer is directly connected to the driving unit 60 to replace it.

The first timing pulley 710 is coupled onto the second rotating shaft member 610, and may have a ring-shaped plate surface. Furthermore, a plurality of first gear teeth 711 may be formed to be spaced apart from each other along the outer circumferential surface of the first timing pulley 710.

The second timing pulley 730 is coupled onto the first rotating shaft member 450, and may have a ring-shaped like the first timing pulley 710. Furthermore, a plurality of second gear teeth 731 may be formed along the outer circumferential surface of the second timing pulley 730. The second timing pulley 730 may include the second gear teeth 731 and has a deceleration rate with respect to the first timing pulley 710. The above deceleration rate is not a fixed value, and may be any value that can reduce a rotating speed of the first rotating shaft member 450 in comparison to a rotating speed of the second rotating shaft member 610.

The timing belt 750 is disposed to surround the first timing pulley 710 and the outer circumferential surface of the second timing pulley 730, and is a belt transmitting a rotatory force that is transmitted through the second rotating shaft member 610 to the first rotating shaft member 450. An inner surface of the timing belt 750 (or, a surface in contact with the outer circumferential surfaces of the first timing pulley 710 and the second timing pulley 730) may include third gear teeth (not shown), and the third gear teeth may be engaged with the first gear teeth 711 and the second gear teeth 731.

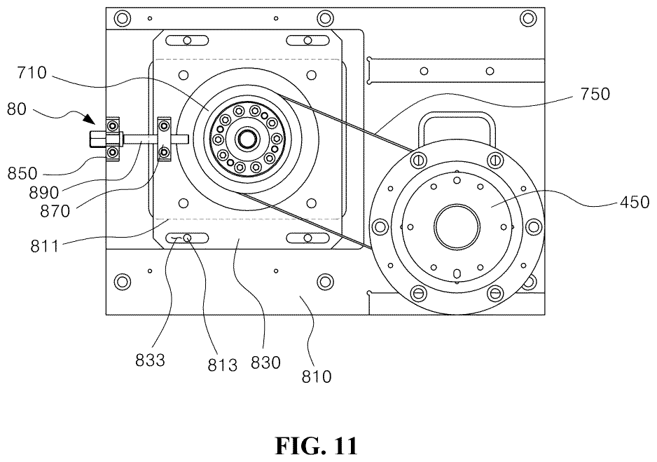

FIG. 11 is an illustrative view showing a tension control unit of FIG. 1.

Referring to FIGS. 2 and 10, the tension control unit 80 is configured to adjust a horizontal position of the second rotating shaft member 610 to control a tension of the timing belt 750. To this end, the tension control unit 80 may include a securing member 810, a transport member 830, a first coupling member 850, and a second coupling member 870. However, the tension control unit 80 is not a main component of the present disclosure, and a separate roller to control the tension of the timing belt 750 may be disposed between the first timing pulley 710 and the second timing pulley 730.

The securing member 810 is seated on the base plate BP. For example, the securing member 810 may have a plate form. The securing member 810 may remain secured at its regular position. Furthermore, the securing member 810 may include a third inserting hole 811 into which a portion of the second rotating shaft member 610 is inserted. Furthermore, the securing member 810 may include a second fastening hole 813 formed at a portion spaced apart from the third inserting hole 811. The second fastening hole 813 matches the fourth long hole 833 of the transport member 830 to be described, and then a coupling means, such as a bolt, is inserted thereinto so that the transport member 830 is secured on the securing member 810.

The transport member 830 is disposed on the securing member 810. The transport member 830 may have a plate form like the securing member 810. The transport member 830 may include a fourth inserting hole 831 into which a portion of the second rotating shaft member 610 is inserted. Furthermore, the transport member 830 may include a fourth long hole 833 formed on a portion spaced apart from the fourth inserting hole 831. Therefore, the fabricator adjusts the horizontal position of the transport member 830, and then inserts and fastens a coupling means, such as a bolt, into the fourth long hole 833 and the second fastening hole 813, thereby securing the position of the transport member 830.

The first coupling member 850 is disposed on the securing member 810 and configured to allow a fastening means 890 to be inserted therein. To this end, a portion of the first coupling member 850 may include a first inserting hole 851 for a fastening means. The first inserting hole 851 for a fastening means is a depressed groove or a through hole that extends in the first direction, and a body of the fastening means 890 may be inserted into the first inserting hole 851.

The second coupling member 870 is disposed on the transport member 830 and configured to allow the fastening means 890 to be inserted therein. To this end, a portion of the second coupling member 870 may include a second inserting hole 871 for a fastening means. The second inserting hole 871 for a fastening means is a depressed groove or a through hole that extends in the first direction, and the body of the fastening means 890 may be inserted into the second inserting hole 871. Therefore, with the configuration of the first coupling member 850 and the second coupling member 870, the transport member 830 may be firmly secured without being moved in the first direction.

Referring to FIGS. 1 to 3, the transport belt 90 is disposed at the output position A2 and configured to transport the electrodes 9, which are discharged to the output position A2 by the suction unit 230, in the horizontal direction. The transport belt 90 may be a transport conveyor. Furthermore, a single electrode 9 supplied to an upper surface of the transport belt 90 may be supplied to a separate electrode pick-and-place unit (not shown). Furthermore, when two or more sheets of electrodes 9 are supplied on the upper surface of the transport belt 90, the transport belt 90 may transport the electrodes 9 in the horizontal direction so that the electrodes 9 are discharged outward. The transport belt 90 may include a plurality of leg units 910 formed on a lower surface thereof, and the leg units 910 may be supported by the base plate BP.

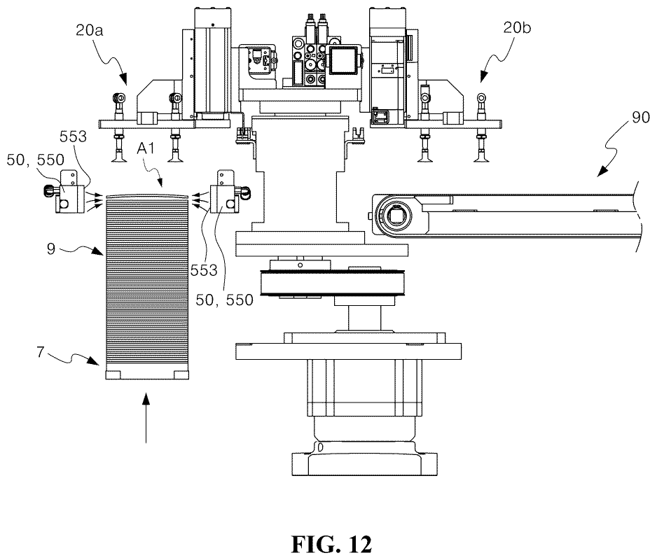

FIGS. 12 to 15 are illustrative views showing a method of transporting secondary battery electrodes according to an embodiment of the present disclosure.

Hereinbelow, according to an embodiment of the present disclosure, a method for transporting secondary battery electrodes will be described in detail with reference to accompanying drawings.

Referring to FIG. 12 first, the electrodes 9 may be supplied to the input position A1. For example, the plurality of electrodes 9 is stacked in the magazine 7 and supplied to the input position A1. Thereafter, the magazine 7 is raised, and the electrodes 9 are positioned at the height of the electrode separating unit 50. Thereafter, the fluid supply member 550, which is a portion of the electrode separating unit 50, supplies a fluid to the plurality of stacked electrodes 9 via the fluid spray hole 553, so that at least a portion of the uppermost electrode 9 is separated from the electrode 9 located immediately below it.

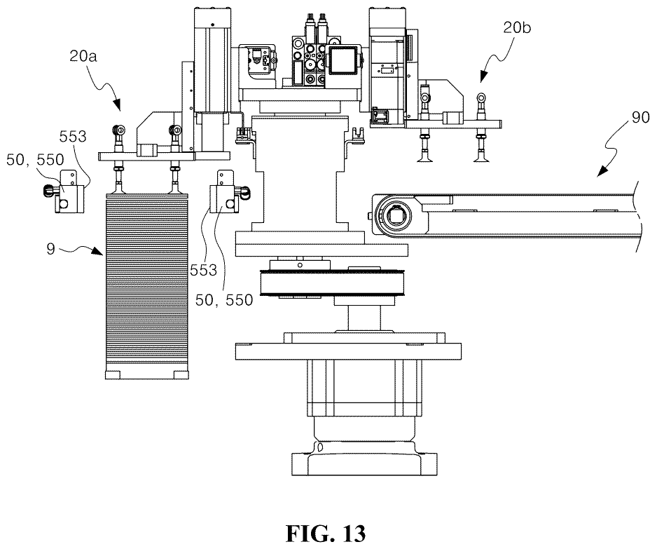

Referring to FIG. 13, thereafter, a portion of the first electrode securing unit 20a may be lowered and suck the uppermost electrode 9 of the plurality of electrodes 9 stacked in the magazine 7 positioned at the input position A1. Thereafter, a portion of the first electrode securing unit 20a may be raised again. At this point, vibrations generated due to the operation of the valve 233, which consists of a pulse valve, and/or repetitive vertical movement of the vertical drive actuator 250 perform multi-sheet separation of the electrodes 9.

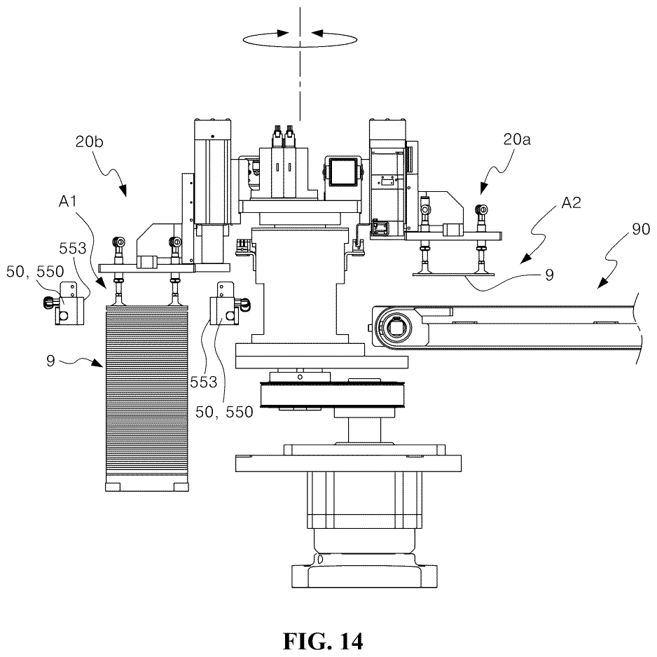

Referring to FIG. 14, thereafter, driving of the driving unit 60 allows a portion of the rotational moving unit 40 to be rotated in the horizontal direction. At this point, the rotational moving unit 40 may rotate forward at a predetermined angle together with the electrode securing units 20. Therefore, the electrode 9 vacuum-sucked by the first electrode securing unit 20a arrives at the output position A2, and the suction unit 230 may be released from vacuum, allowing the electrode 9 to be discharged toward the transport belt 90. At substantially the same time, the second electrode securing unit 20b may repeatedly perform the above-described movements.

Furthermore, when the multi-sheet detecting unit 30 detects multiple sheets of electrodes 9 before the electrode 9 is discharged toward the transport belt 90 by the first electrode securing unit 20a, the transport belt 90 may discharge the electrode 9 outward.

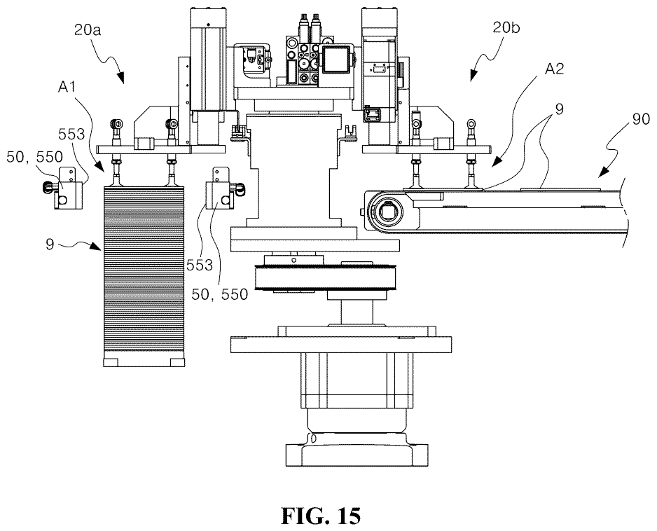

Referring to FIG. 15, thereafter, driving of the driving unit 60 allows a portion of the rotational moving unit 40 to be rotated. At this point, the rotational moving unit 40 may be rotated backward at a predetermined angle. As described above, the driving unit 60 may rotate a portion of the rotational moving unit 40 forward, but does not rotate it in the same direction. After the rotational moving unit 40 is rotated forward, the driving unit 60 may rotate it backward. In the former case, since pneumatic lines, various wires, etc., which are connected to the suction unit 230, the vertical drive actuator 250, etc., are twisted, operation of the latter case is preferable.

Thereafter, the first electrode securing unit 20a may suck the electrode 9 in the magazine 7 at the input position A1, and the second electrode securing unit 20b may discharge the vacuum-sucked electrode 9 at the output position A2.

Hereinabove, the detailed description has illustrated the present disclosure. In addition, the above description shows and describes preferred embodiments of the present disclosure, and the present disclosure can be used in various other combinations, modifications, and environments. In other words, changes or modifications are possible within the scope of the concept of the disclosure disclosed herein, the scope equivalent to the written disclosure, and/or within the scope of skill or knowledge in the art. The above-described embodiments describe the best state for implementing the technical spirit of the present disclosure, and various changes required in the specific application field and use of the present disclosure are possible. Accordingly, the detailed description of the present disclosure is not intended to limit the present disclosure to the disclosed embodiments.

What is claimed is:

1. A transport unit for secondary battery electrodes, the transport unit comprising:
a driving unit;
an electrode securing unit having one portion that is configured to move vertically, and vacuum-sucking electrodes introduced;
a rotational moving unit rotated at one portion in a horizontal direction due to driving of the driving unit, and controlling the electrode securing unit so that the electrode securing unit is reciprocally rotated between an input position and an output position.

2. The transport unit of claim 1, wherein the electrode securing unit comprises:
a suction unit comprising an suction pad at a lower portion thereof to vacuum-suck the electrodes; and
a vertical drive actuator controlling vertical movement of the suction unit.

3. The transport unit of claim 2, wherein the suction unit comprises:
a pulse valve communicating with the suction pad.

4. The transport unit of claim 2, wherein the vertical drive actuator is configured to repeat vertical movements to perform multi-sheet separation of the electrodes that are vacuum-sucked by the suction unit.

5. The transport unit of claim 3, wherein the pulse valve is configured to generate pressure waves in the electrodes, which are vacuum-sucked by the suction unit, to perform multi-sheet separation of the electrodes that are vacuum-sucked by the suction unit.

6. The transport unit of claim 5, wherein the suction unit comprises a plurality of suction units that are spaced apart from each other, and
the pulse valve of each suction unit, which sucks opposite ends or edges of the electrodes, generates pressure waves in the electrodes along the corresponding suction pad.

7. The transport unit of claim 2, wherein the electrode securing unit comprises:
a coupling plate extending in a first direction; and
a suction unit securing member coupled to the coupling plate and provided with the suction unit that is secured to one portion of the suction unit securing member,
wherein the coupling plate comprises:
a first long hole extending in the first direction, and
the suction unit securing member comprises:
a fastening hole matching the first long hole so that a coupling means is inserted.

8. The transport unit of claim 2, wherein the electrode securing unit comprises:
a coupling plate extending in a first direction; and
a suction unit securing member coupled to the coupling plate and provided with the suction unit that is secured to one portion of the suction unit securing member,
wherein the suction unit securing member comprises:
a second long hole extending in a second direction orthogonal to the first direction, and
the suction unit is inserted into the second long hole.

9. The transport unit of claim 2, further comprising:
a multi-sheet detecting unit configured to detect whether the suction unit vacuum-sucks multiple sheets of electrodes,
wherein the multi-sheet detecting unit comprises:
a transmitter located at one portion of the electrode securing unit; and
a receiver located below the transmitter.

10. The transport unit of claim 1, wherein the rotational moving unit comprises:
a base member to which one portion of the electrode securing unit is coupled; and
a first rotating shaft member arranged below the base member and rotated in the horizontal direction using a rotatory force transmitted by the driving unit,
wherein the base member comprises:
a through hole formed in a vertical direction, and
the first rotating shaft member comprises:
a hollow portion extending in the vertical direction and communicating with the through hole.

11. The transport unit of claim 10, wherein the rotational moving unit further comprises:
a cover that covers the first rotating shaft member and is fixed at its regular position; and
a rotation detector provided on an outer surface of the cover, and detecting a rotating angle or a relative position of the first rotating shaft member, and
the electrode securing unit comprises:
a protruding member protruding from one portion of the electrode securing unit, and passing through one portion of the rotation detector.

12. The transport unit of claim 1, further comprising:
an electrode separating unit that sprays a fluid to the electrodes supplied to the input position.

13. The transport unit of claim 12, wherein the electrode separating unit comprises:
a pair of securing portions spaced apart from each other in the first direction;
a connection rod having opposite ends that are respectively connected to the pair of securing portions; and
a fluid supply member coupled to the connection rod, and spraying the fluid outward.

14. The transport unit of claim 1, wherein the rotational moving unit comprises:
a base member to which one portion of the electrode securing unit is coupled; and
a first rotating shaft member arranged below the base member and rotated in the horizontal direction using a rotatory force transmitted by the driving unit,
the driving unit comprises:
a second rotating shaft member extending in a vertical direction, and
the deceleration control unit comprises:
a first timing pulley coupled onto the second rotating shaft member, and comprising first gear teeth formed along an outer circumferential surface thereof;
a second timing pulley coupled onto the first rotating shaft member, and comprising second gear teeth formed along an outer circumferential surface thereof; and
a timing belt surrounding the outer circumferential surfaces of the first timing pulley and the second timing pulley.

15. The transport unit of claim 1, wherein the electrode securing unit includes a plurality of electrode securing units that are arranged on the rotational moving unit while being spaced apart from each other at a predetermined angle in a rotating direction of a portion of the rotational moving unit.

16. A method for transporting secondary battery electrodes performed by the transport unit for secondary battery electrodes according to claim 1, the method comprising:
vacuum-sucking, by the suction unit, an electrode located at the uppermost end among a plurality of electrodes that are stacked in a magazine;
rotating, by driving of the driving unit, the rotational moving unit forward in a horizontal direction;
finishing, by the suction unit, vacuum suction with respect to the electrode after forward rotation of the rotational moving unit; and
rotating, by driving of the driving unit, the rotational moving unit backward in the horizontal direction to be returned to its original position.

17. The method of claim 16, further comprising:
an electrode separating unit configured to supply fluid to electrodes supplied to the input position, and
spraying the fluid onto a plurality of electrodes that are stacked in the magazine before the suction unit vacuum-sucks an electrode.

18. The method of claim 16, wherein the electrode securing unit comprises:
a pulse valve communicating with the suction pad, and
the method further comprises:
after the suction unit vacuum-sucks the electrodes, generating pressure waves using the pulse valve and separating multiple sheets of electrodes sucked by the suction unit.

19. The method of claim 16, wherein the electrode securing unit comprises:
a vertical drive actuator controlling upward and downward movements of the suction unit, and
the method further comprises:
separating multiple sheets of electrodes sucked by the suction unit, with repeated vertical movements of the vertical drive actuator.

20. The method of claim 16, wherein the electrode securing unit comprises:
a pulse valve connected to the suction pad; and a vertical drive actuator controlling upward and downward movements of the suction unit, and
the method further comprises:
after the suction unit vacuum-sucks the electrodes, generating pressure waves using the pulse valve and separating multiple sheets of electrodes sucked by the suction unit; and
separating multiple sheets of electrodes sucked by the suction unit, with repeated upward and downward movements of the vertical drive actuator.
